(19) United States
(12) Patent Application Publication
(10) Pub. No.: US 2011/0304715 A1
(43) Pub. Date: Dec. 15, 2011

(54) Video Display Apparatus and Shutter Glasses

(76) Inventors: Kazuhiro Yamada, Ome-shi (JP); Masahiro Yamada, Hinode-cho (JP)

(21) Appl. No.: 13/021,536

(22) Filed: Feb. 4, 2011

(30) Foreign Application Priority Data
Jun. 15, 2010 (JP) 2010-136085

(51) Int. Cl. H04N 13/04

(52) U.S. Cl. 348/54; 348/51; 348/E13.075; 348/E13.074

(57) ABSTRACT

According to one embodiment, a video display apparatus includes a cabinet; and a glasses housing box. The glasses housing box is provided in the cabinet and configured to house at least one pair of shutter glasses.

### CROSS REFERENCE TO RELATED APPLICATION(S)

This application is based upon and claims the benefit of priority from Japanese Patent Application No. 2010-136085 filed on Jun. 15, 2010, the entire contents of which are incorporated herein by reference.

### BACKGROUND

1. Field

Embodiments described herein relate generally to a video display apparatus capable of displaying 3D video, and shutter glasses.

2. Description of the Related Art

In recent years, flat panel displays which enable viewing of 3D video contents have been put into practical use. Among various 3D video display methods so far proposed are glass methods which use polarization filter glasses or electronic shutter glasses.

The electronic shutter glasses incorporate shutters that operate (i.e., are opened and closed) in synchronism with video. When a right-eye image is displayed, the left-eye shutter is closed and the user can see the right-eye image only with his or her right eye. When a left-eye image displayed, the right-eye shutter is closed and the user can see the left-eye image only with his or her left eye. The user sees video having a parallax with his or her right and left eyes alternately as the shutters of the glasses are opened and closed electronically in synchronism with video, and can thus recognize it three-dimensionally.

The electronic shutter glasses use liquid crystal shutters and need to be supplied with power to open and close the liquid crystal shutters. Power is supplied from a primary battery or a secondary battery housed in the electronic shutter glasses. In the case of a primary battery, a small one such as a button battery is used. When the primary battery goes dead, it needs to be replaced by a new one. In the case of a secondary battery, it needs to be charged when used up. Charging is done by connecting the secondary battery to a dedicated charger by a dedicated cable or to a USB (universal serial bus) terminal by a USB cable.

In ordinary homes, in many cases, 3D video is viewed by multiple viewers, which means that multiple pairs of electronic shutter glasses are necessary. On the other hand, electronic shutter glasses are not necessary when a non-3D broadcast program is viewed. Therefore, it is expected that pairs of electronic shutter glasses lie scattered. To prevent such a state, it would be necessary to secure a place where to lay down or store pairs of electronic shutter glasses. Furthermore, where a secondary battery is used for electronic shutter glasses, multiple chargers may be necessary.

### BRIEF DESCRIPTION OF THE SEVERAL VIEWS OF THE DRAWINGS

A general configuration that implements the various features of the invention will be described with reference to the drawings. The drawings and the associated descriptions are provided to illustrate embodiments of the invention and not to limit the scope of the invention.

FIG. 1 shows an exemplary general appearance of a video display apparatus according to a first embodiment;

FIG. 2 is an exemplary sectional view of the video display apparatus taken along line A-A in FIG. 1;

FIG. 3 shows an exemplary general appearance of shutter glasses;

FIG. 4 shows an exemplary state that a housing portion lid is opened in the video display apparatus according to the first embodiment;

FIG. 5 shows an exemplary state that shutter glasses are mounted on a glasses stand;

FIGS. 6A and 6B show exemplary charging terminals of each pair of shutter glasses;

FIGS. 7A and 7B show exemplary power supply terminals of the glasses stand;

FIG. 8 shows an exemplary state that the charging terminals of the shutter glasses are in contact with the respective power supply terminals of the glasses stand;

FIG. 9 shows an exemplary general appearance of a video display apparatus according to a second embodiment;

FIG. 10 shows an exemplary state that a housing portion lid is opened in the video display apparatus according to the second embodiment;

FIG. 11 shows an exemplary general appearance of a video display apparatus according to a third embodiment;

FIG. 12 shows an exemplary stand of the video display apparatus according to the third embodiment;

FIG. 13 shows an exemplary state that a housing portion lid is opened in the video display apparatus according to the third embodiment;

FIG. 14 shows an exemplary general appearance of a video display apparatus according to a fourth embodiment;

FIG. 15 is an exemplary sectional view, taken along line D-D in FIG. 14, of the video display apparatus according to the fourth embodiment;

FIG. 16 shows an exemplary state that a housing portion lid is opened in the video display apparatus according to the fourth embodiment;

FIGS. 17A and 17B show an exemplary shutter glasses according to a fifth embodiment; and

FIG. 18 shows an exemplary state that the charging terminals of the shutter glasses are in contact with respective power supply terminals of the glasses stand.

### DETAILED DESCRIPTION

In general, according to one embodiment, a video display apparatus includes a cabinet; and a glasses housing box. The glasses housing box is provided in the cabinet and configured to house at least one pair of shutter glasses.

Exemplary embodiments will be hereinafter described with reference to the drawings.

### First Embodiment

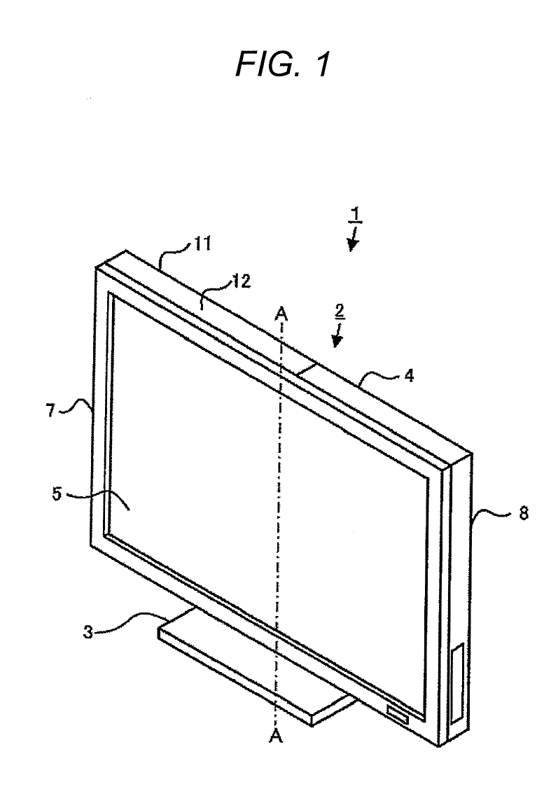

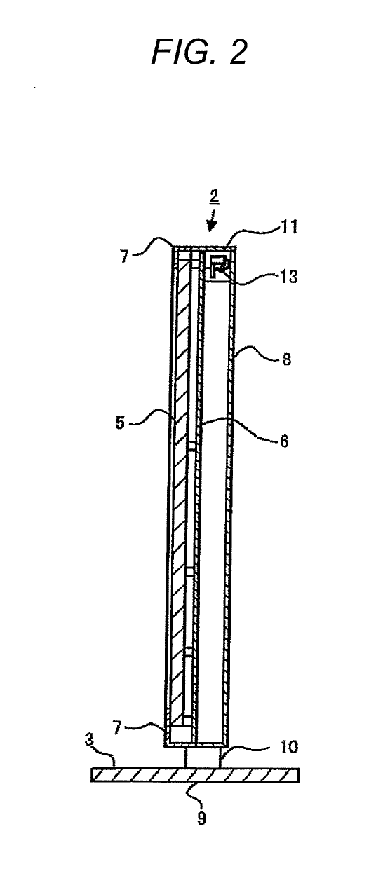

FIG. 1 shows an exemplary general appearance of a video display apparatus 1 according to a first embodiment. FIG. 2 is an exemplary sectional view of the video display apparatus 1 taken along line A-A in FIG. 1.

The video display apparatus 1 is equipped with a main body 2 and a stand 3 which supports the main body 2. The main body 2 is composed of a cabinet 4, a display panel 5, a frame 6, etc. The display panel 5 such as a liquid crystal panel or a PDP (plasma display panel) occupies a front space of the main body 2 and the frame 6 which supports the display panel 5 is disposed behind the display panel 5. The frame 6 is provided with a circuit board and a power circuit (not shown) for driving the display panel 5.

A bottom, approximately central portion of the main body 2 is joined to the stand 3 and the main body 2 is thereby supported by the stand 3. The stand 3 has a support portion 10 which is erected approximately vertically from a pedestal 9 and joined to the frame 6 with screws or the like.

The cabinet 4 is composed of a front cover 7 which covers the front surface and parts of the top surface, the bottom surface, and the two side surfaces of the combination of the display panel 5 and the frame 6 and a back cover 8 which covers the back surface and the remaining parts of the top surface, the bottom surface, and the two side surfaces of the combination of the display panel 5 and the frame 6.

A top portion of the cabinet 4 is formed with a glasses housing portion 11 for housing pairs of shutter glasses 13. The glasses housing box 11 has a housing portion lid 12. When a viewer wants to use shutter glasses 13, he or she opens the housing portion lid 12 and takes out shutter glasses 13 from the glasses housing box 11. The glasses housing box 11 can accommodate one of multiple pairs of shutter glasses 13.

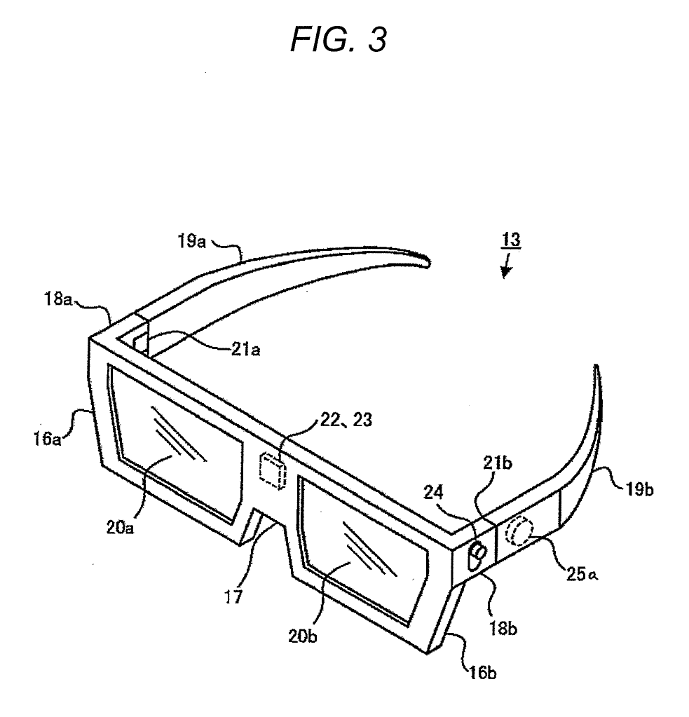

FIG. 3 shows an exemplary general appearance of shutter glasses 13. The shutter glasses 13 are composed of rims 16a and 16b, a bridge 17, armors 18a and 18b, temples 19a and 19b, and liquid crystal shutters 20a and 20b. The temples 19a and 19b are attached rotatably to the armors 18a and 18b via hinges 21a and 21b, respectively.

The bridge 17 contains a receiving unit 22 for receiving a control signal transmitted from the video display apparatus 1 and a control unit 23 for controlling operations of the liquid crystal shutters 20a and 20b. The left armor 18b is provided with a power switch 24. A secondary battery 25a for supplying power for operation of the liquid crystal shutters 20a and 20b is provided in the left temple 19b near the armor 18b.

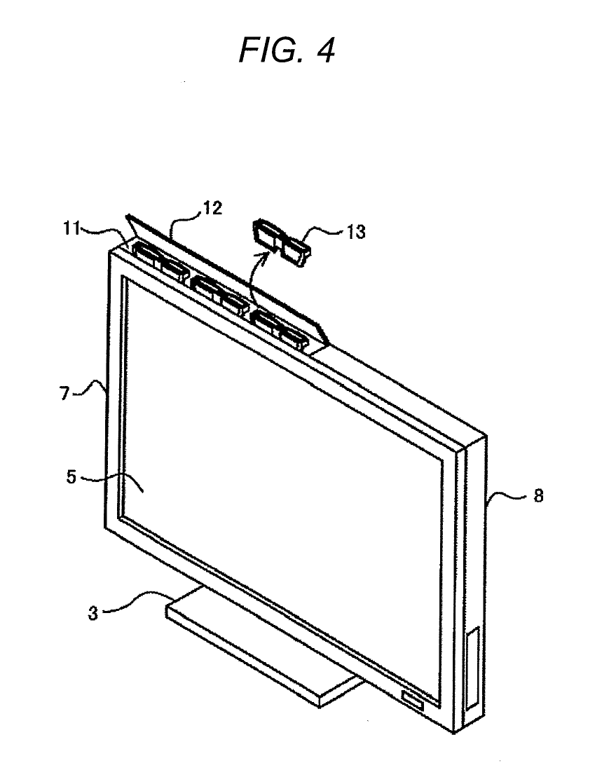

FIG. 4 shows an exemplary state that the housing portion lid 12 is opened in the video display apparatus 1. The glasses housing box 11 can accommodate multiple pairs of shutter glasses 13 whose temples 19a and 19b are folded. Although FIG. 4 shows three pairs of shutter glasses 13, it goes without saying that several pairs of shutter glasses 13 can be housed additionally in the glasses housing box 11.

A viewer takes out shutter glasses 13 from the glasses housing box 11 when he or she wants to view 3D video, and returns them to the glasses housing box 11 after viewing the 3D video. With this measure, the pairs of shutter glasses 13 are located at the fixed place and hence multiple viewers can easily recognize the location of the pairs of shutter glasses 13 and use them.

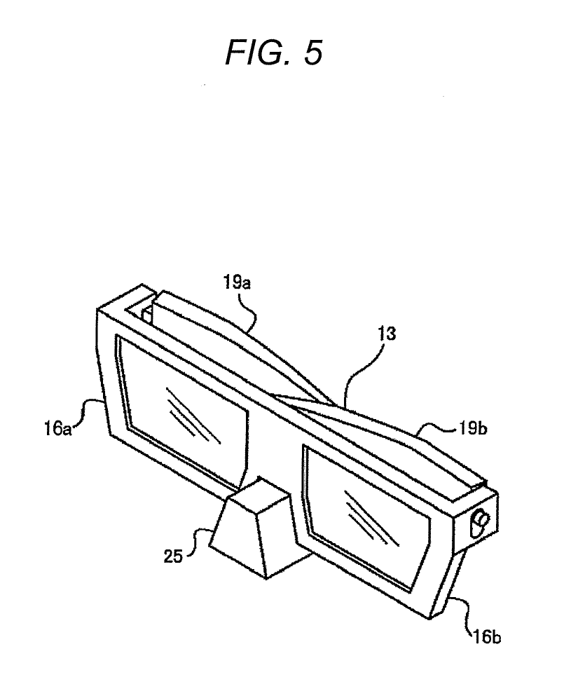

FIG. 5 shows an exemplary state that shutter glasses 13 are mounted on a glasses stand 25 in such a manner that their temples 19a and 19b are folded. The bottom surface of the glasses housing box 11 is formed with a glasses stand(s) 25. One glasses stand 25 is formed or glasses stands 25 are formed in a number that is the same as or smaller than the number of pairs of shutter glasses 13 that can be accommodated in the glasses housing box 11. The top shape of each glasses stand 25 is similar to the shape formed by of a bottom portion of the bridge 17 and adjacent portions of the rims 16 so that the shutter glasses 13 can be mounted thereon stably. In the example of FIG. 5, the top portion of the glasses stand 25 has a generally trapezoidal shape.

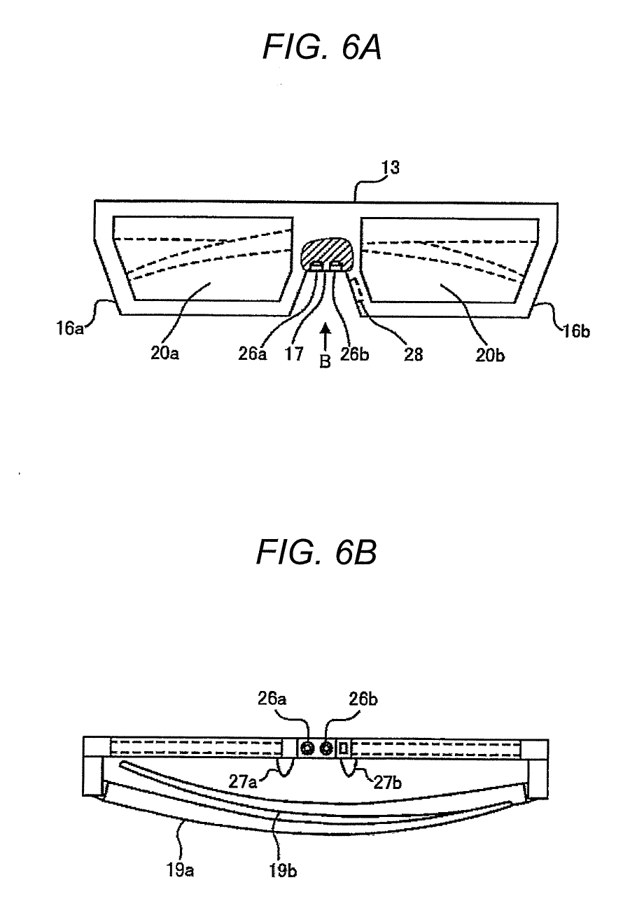

FIGS. 6A and 6B show exemplary charging terminals 26a and 26b of each pair of shutter glasses 13. FIG. 6A is a view in which the shutter glasses 13 are viewed from the side of the liquid crystal shutters 20a and 20b. The charging terminals 26a and 26b are provided in a bottom portion of the bridge 17. The charging terminals 26a and 26b are shown in a sectional view that is part of FIG. 6A.

FIG. 6B is a view in which the shutter glasses 13 are viewed from the direction B in FIG. 6A. The charging terminals 26a and 26b appear side by side in the bottom surface of the bridge 17. The rims 16a and 16b are provided with respective nose pads 27a and 27b at positions that are close to the bridge 17.

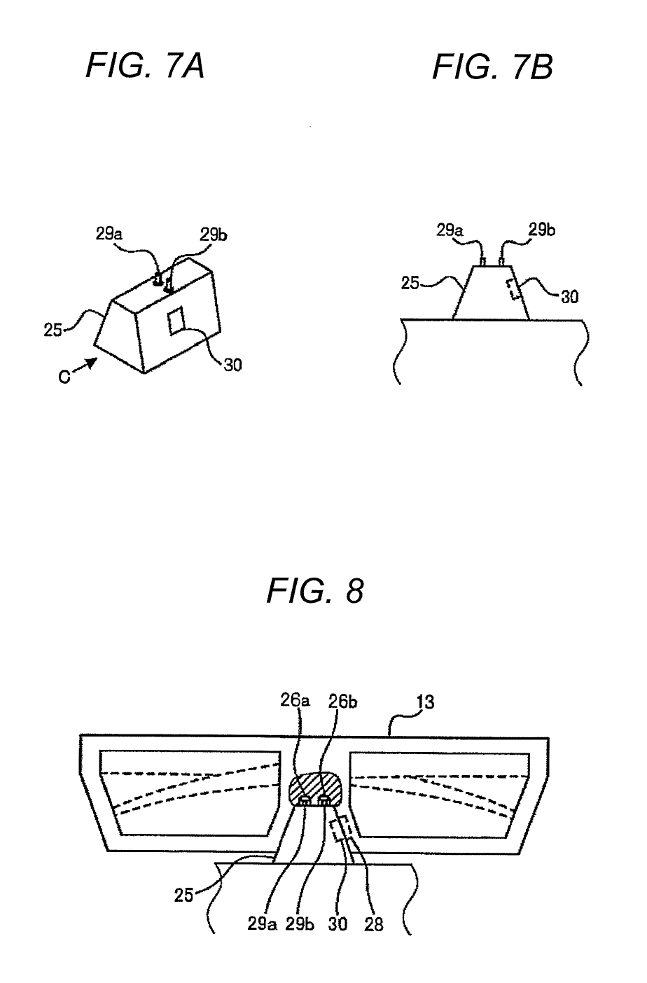

A metal piece 28 is buried in the rim 16b at a position that is close to the bridge 17. The metal piece 28 is made of a metal that can be attracted by a magnet. The metal piece 28 is buried in the rim 16b in such a manner that its exposed surface is approximately flush with the surface of the rim 16b. The metal piece 28 is provided at such a position as to be attracted by a magnet 30 (see FIGS. 7A and 7B) that is buried in the glasses stand 25 when the shutter glasses 13 are mounted on the glasses stand 25.

FIGS. 7A and 7B show exemplary power supply terminals 29a and 29b of the glasses stand 25. FIG. 7A shows a general appearance of the glasses stand 25, and FIG. 7B is a view in which the glasses stand 25 is viewed from the direction C in FIG. 7A. The top surface of the glasses stand 25 is provided with the power supply terminals 29a and 29b. The magnet 30 which is a ferrite magnet or the like is buried in a side wall of the glasses stand 25 near the power supply terminal 29a or 29b. The magnet 30 is buried in such a manner that its exposed surface is approximately flush with the side surface of the glasses stand 25.

FIG. 8 shows an exemplary state that shutter glasses 13 are mounted on the glasses stand 25 and the charging terminals 26a and 26b of the shutter glasses 13 are in contact with the respective power supply terminals 29a and 29b of the glasses stand 25. When the shutter glasses 13 are mounted on the glasses stand 25 so as to face the respective power supply terminals 29a and 29b of the glasses stand 25, the charging terminals 26a and 26b come into contact with the power supply terminals 29a and 29b and the secondary battery 25a of the shutter glasses 13 is charged.

The magnet 30 of the glasses stand 25 attracts the metal piece 28 of the shutter glasses 13, whereby the mounting state of the shutter glasses 13 is kept stable and the states of connections between the charging terminals 26a and 26b and hence the power supply terminals 29a and 29b are kept good. The attraction force acting between the magnet 30 and the metal piece 28 is about 0.5 to 2 N.

After viewing 3D video, a viewer puts the shutter glasses 13 into the glasses housing box 11. Since the glasses stand(s) 25 is formed in the glasses housing box 11 and provided with the power supply terminals 29a and 29b, the secondary battery 25a of the shutter glasses 13 is charged when the viewer mounts the shutter glasses 13 on the glasses stand 25 at the prescribed position. Multiple viewers can thus perform charging on pairs of shutter glasses 13 easily, and use pairs of shutter glasses 13 whose batteries 25a have been charged up when they want to do so.

### Second Embodiment

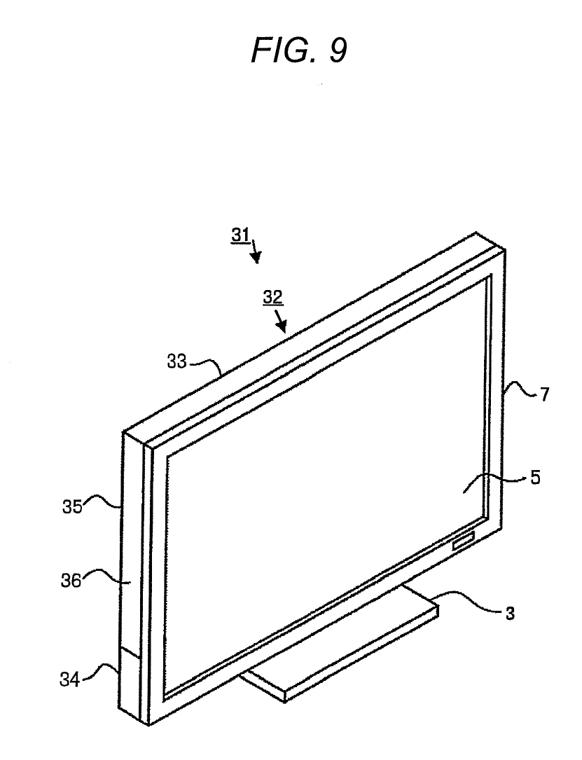

FIG. 9 shows an exemplary general appearance of a video display apparatus 31 according to a second embodiment. Individual members etc. of the second embodiment having corresponding ones in the first embodiment (see FIGS. 1-8) will be given the same reference symbols as the latter. Whereas in the first embodiment the glasses housing box 11 is provided in the top portion of the cabinet 4, in the second embodiment a glasses housing box 35 is provided in a side end portion of a cabinet 33.

The video display apparatus 31 is equipped with a main body 32 and a stand 3 which supports the main body 32. The main body 32 is composed of the cabinet 33, a display panel 5, a frame 6, etc. The display panel 5 such as a liquid crystal panel or a PDP occupies a front space of the main body 32 and the frame 6 which supports the display panel 5 is disposed behind the display panel 5. The frame 6 is provided with a circuit board and a power circuit (not shown) for driving the display panel 5.

The cabinet 33 is composed of a front cover 7 which covers the front surface and parts of the top surface, the bottom surface, and the two side surfaces of the combination of the display panel 5 and the frame 6 and a back cover 34 which covers the back surface and the remaining parts of the top surface, the bottom surface, and the two side surfaces of the combination of the display panel 5 and the frame 6.

A side end portion of the cabinet 33 is formed with a glasses housing portion 35 for housing pairs of shutter glasses 13. The glasses housing box 35 has a housing portion lid 36. When a viewer wants to use shutter glasses 13, he or she opens the housing portion lid 36 and takes out shutter glasses 13 from the glasses housing box 35. The glasses housing box 35 can accommodate one or multiple pairs of shutter glasses 13.

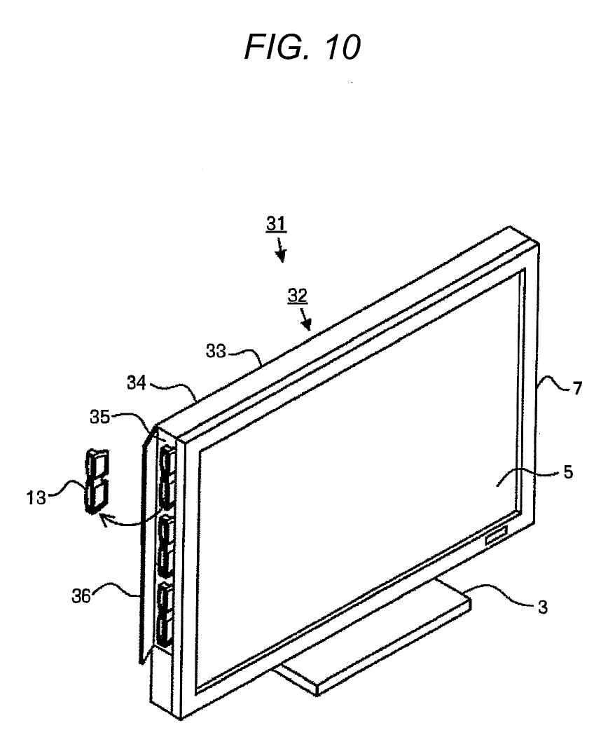

FIG. 10 shows an exemplary state that the housing portion lid 36 is opened in the video display apparatus 31. The glasses housing box 35 can accommodate multiple pairs of shutter glasses 13 whose temples 19a and 19b are folded. FIG. 10 shows an example in which three pairs of shutter glasses 13 are housed in the glasses housing box 35.

A viewer takes out shutter glasses 13 from the glasses housing box 35 when he or she wants to view 3D video, and returns them to the glasses housing box 35 after viewing the 3D video. With this measure, the pairs of shutter glasses 13 are located at the fixed place and hence multiple viewers can easily recognize the location of the pairs of shutter glasses 13 and use them.

After viewing 3D video, a viewer puts the shutter glasses 13 into the glasses housing box 35. Since the glasses stand(s) 25 is foamed in the glasses housing box 35 and provided with power supply terminals 29a and 29b, the secondary battery 25a of the shutter glasses 13 is charged when the viewer mounts the shutter glasses 13 on the glasses stand 25 at a prescribed position. Multiple viewers can thus perform charging on pairs of shutter glasses 13 easily, and use pairs of shutter glasses 13 whose batteries 25a have been charged up when they want to do so.

### Third Embodiment

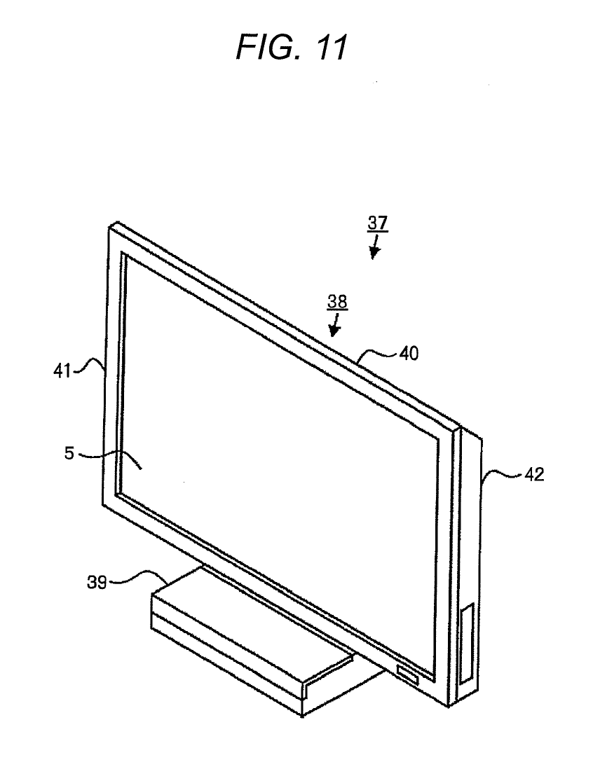

FIG. 11 shows an exemplary general appearance of a video display apparatus 37 according to a third embodiment. Individual members etc. of the third embodiment having corresponding ones in the first embodiment (see FIGS. 1-8) will be given the same reference symbols as the latter. Whereas in the first embodiment the glasses housing box 11 is provided in the top portion of the cabinet 4, in the third embodiment a glasses housing box 45 is provided in a stand 39.

The video display apparatus 37 is equipped with a main body 38 and a stand 39 which supports the main body 38. The main body 38 is composed of a cabinet 40, a display panel 5, a frame 6, etc. The display panel 5 such as a liquid crystal panel or a PDP occupies a front space of the main body 38 and the frame 6 which supports the display panel 5 is disposed behind the display panel 5. The frame 6 is provided with a circuit board and a power circuit (not shown) for driving the display panel 5.

The cabinet 40 is composed of a front cover 41 which covers the front surface and parts of the top surface, the bottom surface, and the two side surfaces of the combination of the display panel 5 and the frame 6 and a back cover 42 which covers the back surface and the remaining parts of the top surface, the bottom surface, and the two side surfaces of the combination of the display panel 5 and the frame 6.

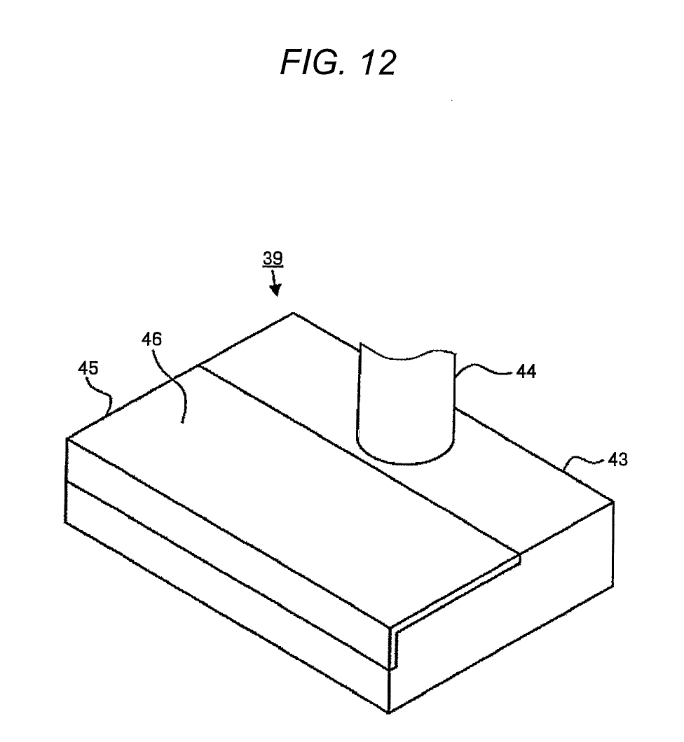

FIG. 12 shows the exemplary stand 39 of the video display apparatus 37 according to the third embodiment. A bottom, approximately central portion of the main body 38 is joined to the stand 39 and the main body 38 is thereby supported by the stand 39. The stand 39 has a support portion 44 which is erected approximately vertically from a pedestal 43 and joined to the frame 6 with screws or the like.

The stand 39 is formed with a glasses housing box 45 for housing pairs of shutter glasses 13. The glasses housing box 45 has a housing portion lid 46 at the top. When a viewer wants to use shutter glasses 13, he or she opens the housing portion lid 46 and takes out shutter glasses 13 from the glasses housing box 45. The glasses housing box 45 can accommodate one or multiple pairs of shutter glasses 13.

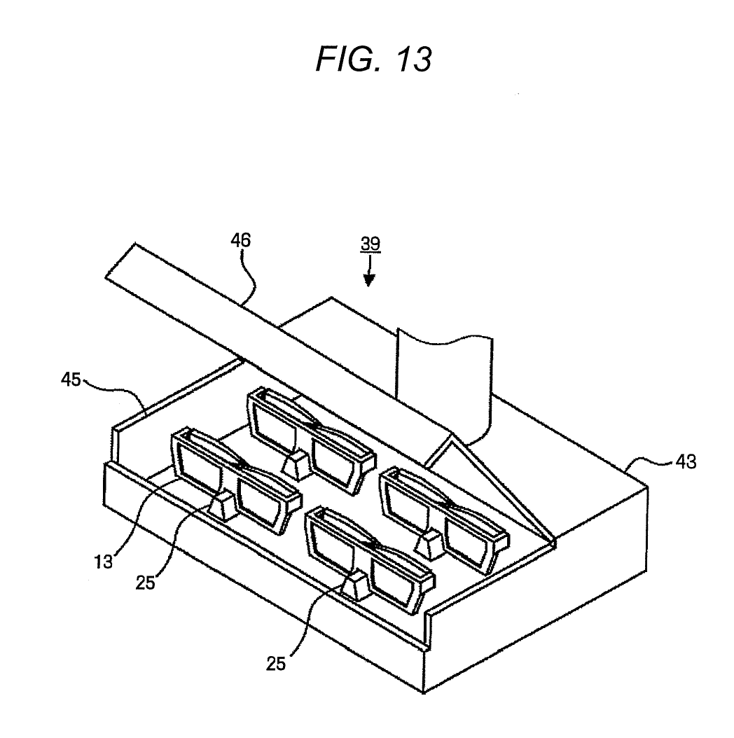

FIG. 13 shows an exemplary state that the housing portion lid 46 is opened in the video display apparatus 37 according to the third embodiment. The glasses housing box 45 can accommodate multiple pairs of shutter glasses 13 whose temples 19a and 19b are folded. Although FIG. 13 shows four pairs of shutter glasses 13, several pairs of shutter glasses 13 can be housed additionally in the glasses housing box 45.

A viewer takes out shutter glasses 13 from the glasses housing box 45 when he or she wants to view 3D video, and returns them to the glasses housing box 45 after viewing the 3D video. With this measure, the pairs of shutter glasses 13 are located at the fixed place and hence multiple viewers can easily recognize the location of the pairs of shutter glasses 13 and use them.

The bottom surface of the glasses housing box 45 is formed with a glasses stand(s) 25. One glasses stand 25 is formed or glasses stands 25 are formed in a number that is the same as or smaller than the number of pairs of shutter glasses 13 that can be accommodated in the glasses housing box 45. The glasses stand 25 is the same as in the first embodiment and will not be described below in detail.

After viewing 3D video, a viewer puts the shutter glasses 13 into the glasses housing box 45. Since the glasses stand(s) 25 is formed in the glasses housing box 45 and provided with power supply terminals 29a and 29b, the secondary battery 25a of the shutter glasses 13 is charged when the viewer mounts the shutter glasses 13 on the glasses stand 25 at a prescribed position. Multiple viewers can thus perform charging on pairs of shutter glasses 13 easily, and use pairs of shutter glasses 13 whose batteries 25a have been charged up when they want to do so.

### Fourth Embodiment

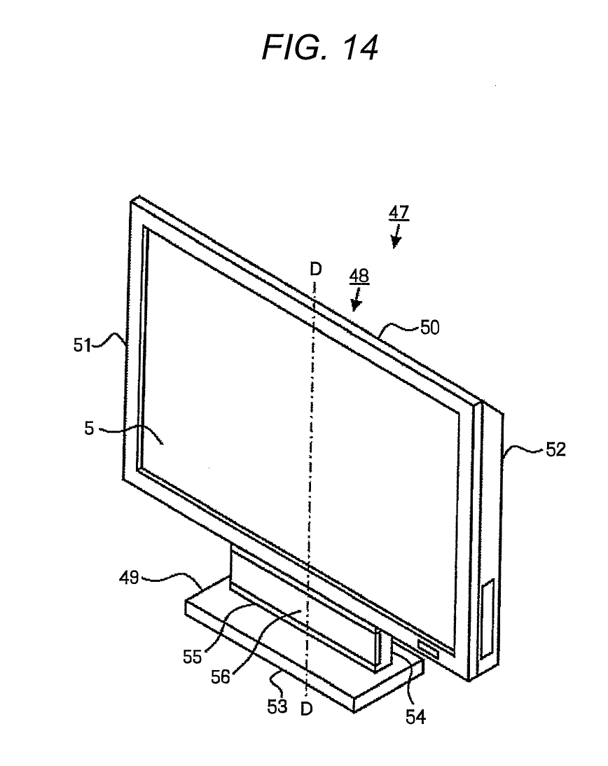

FIG. 14 shows an exemplary general appearance of a video display apparatus 47 according to a fourth embodiment. Individual members etc. of the fourth embodiment having corresponding ones in the first embodiment (see FIGS. 1-8) will be given the same reference symbols as the latter. Whereas in the first embodiment the glasses housing box 11 is provided in the top portion of the cabinet 4, in the fourth embodiment a glasses housing box 55 is provided in a support portion 54 of a stand 49.

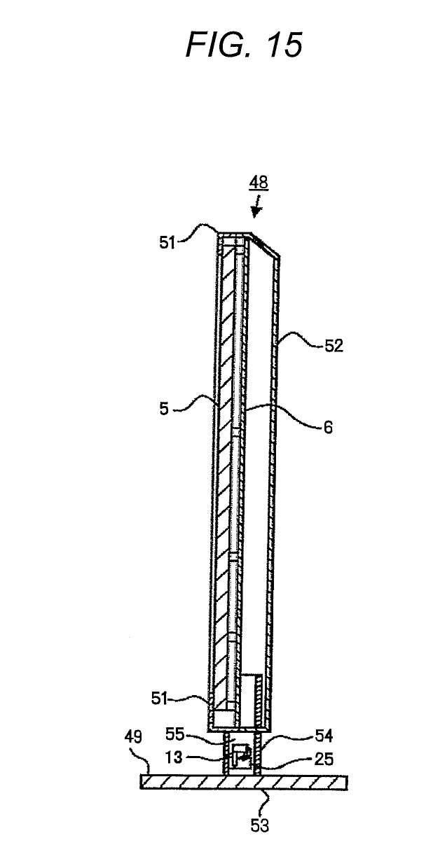

FIG. 15 is an exemplary sectional view, taken along line D-D in FIG. 14, of the video display apparatus 47 according to the fourth embodiment. The video display apparatus 47 is equipped with a main body 48 and the stand 49 which supports the main body 48. The main body 48 is composed of a cabinet 50, a display panel 5, a frame 6, etc. The display panel 5 such as a liquid crystal panel or a PDP occupies a front space of the main body 48 and the frame 6 which supports the display panel 5 is disposed behind the display panel 5. The frame 6 is provided with a circuit board and a power circuit (not shown) for driving the display panel 5.

A bottom, approximately central portion of the main body 48 is joined to the stand 49 and the main body 48 is thereby supported by the stand 49. The stand 49 has the support portion 54 which is erected approximately vertically from a pedestal 53 and joined to the frame 6 with screws or the like.

The cabinet 50 is composed of a front cover 51 which covers the front surface and parts of the top surface, the bottom surface, and the two side surfaces of the combination of the display panel 5 and the frame 6 and a back cover 52 which covers the back surface and the remaining parts of the top surface, the bottom surface, and the two side surfaces of the combination of the display panel 5 and the frame 6.

The support portion 54 of the stand 49 is formed with a glasses housing box 55 for housing pairs of shutter glasses 13. The glasses housing box 55 has a housing portion lid 56. When a viewer wants to use shutter glasses 13, he or she opens the housing portion lid 56 and takes out shutter glasses 13 from the glasses housing box 55. The glasses housing box 55 can accommodate one or multiple pairs of shutter glasses 13.

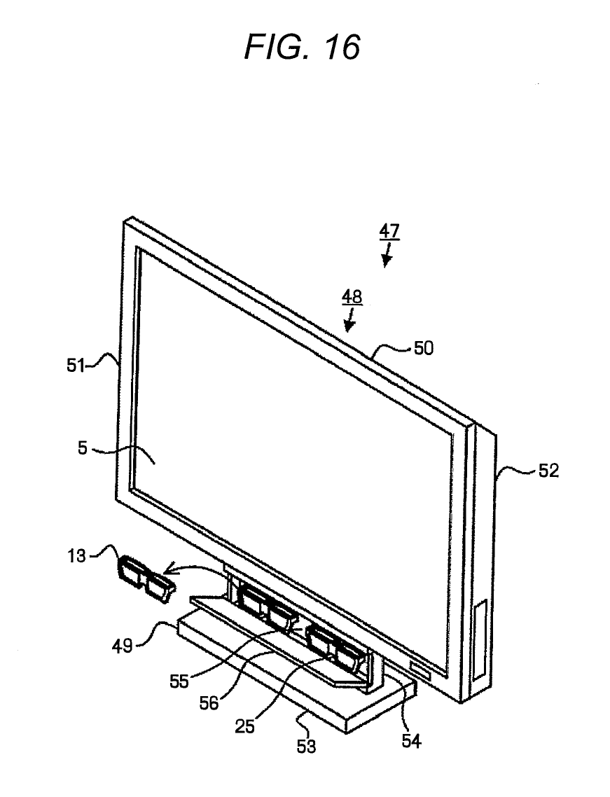

FIG. 16 shows an exemplary state that the housing portion lid 56 is opened in the video display apparatus 47 according to the fourth embodiment. The glasses housing box 55 can accommodate multiple pairs of shutter glasses 13 whose temples 19a and 19b are folded. FIG. 16 shows an example in which two pairs of shutter glasses 13 are housed in the glasses housing box 55.

A viewer takes out shutter glasses 13 from the glasses housing box 55 when he or she wants to view 3D video, and returns them to the glasses housing box 55 after viewing the 3D video. With this measure, the pairs of shutter glasses 13 are located at the fixed place and hence multiple viewers can easily recognize the location of the pairs of shutter glasses 13 and use them.

The bottom surface of the glasses housing box 55 is formed with a glasses stand(s) 25. One glasses stand 25 is formed or glasses stands 25 are formed in a number that is the same as or smaller than the number of pairs of shutter glasses 13 that can be accommodated in the glasses housing box 55. The glasses stand 25 is the same as in the first embodiment and will not be described below in detail.

After viewing 3D video, a viewer puts the shutter glasses 13 into the glasses housing box 55. Since the glasses stand(s) 25 is formed in the glasses housing box 55 and provided with power supply terminals 29a and 29b, the secondary battery 25a of the shutter glasses 13 is charged when the viewer mounts the shutter glasses 13 on the glasses stand 25 at a prescribed position. Multiple viewers can thus perform charging on pairs of shutter glasses 13 easily, and use pairs of shutter glasses 13 whose batteries 25a have been charged up when they want to do so.

### Fifth Embodiment

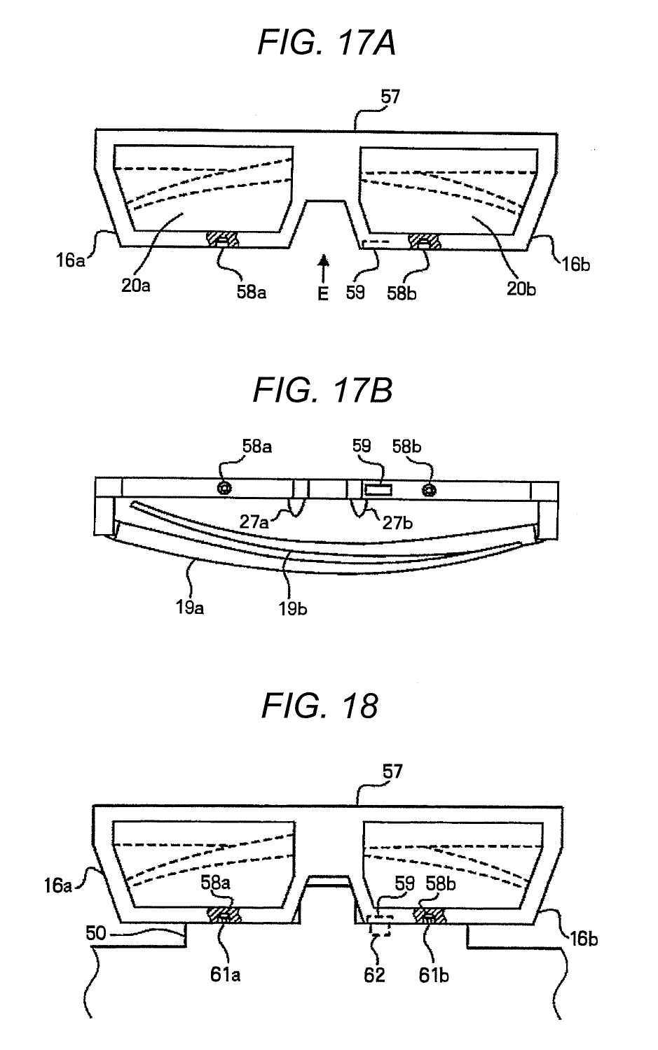

FIGS. 17A and 17B show an exemplary shutter glasses 57 according to a fifth embodiment. Individual members etc. of shutter glasses 57 according to the fifth embodiment having corresponding ones in the shutter glasses 13 according to the first embodiment (see FIG. 3 and FIGS. 6A and 6B) will be given the same reference symbols as the latter. Whereas in the shutter glasses 13 according to the first embodiment the charging terminals 26a and 26b are provided in the bottom portion of the bridge 17, in the shutter glasses 57 according to the fifth embodiment charging terminals 58a and 58b are provided in bottom portions of rims 16a and 16b, respectively.

FIG. 17A is a view in which the shutter glasses 57 are viewed from the side of liquid crystal shutters 20a and 20b. The charging terminals 58a and 58b are provided in bottom portions of the rims 16a and 16b, respectively. The charging terminals 58a and 58b are shown in sectional views that are parts of FIG. 17A.

FIG. 17B is a view in which the shutter glasses 57 are viewed from the direction E in FIG. 17A. The charging terminals 58a and 58b are provided in the bottom portions of the rims 16a and 16b. A metal piece 59 is buried in the rim 16b. The metal piece 59 is made of a metal that can be attracted by a magnet. The metal piece 59 is buried in the rim 16b in such a manner that its exposed surface is approximately flush with the surface of the rim 16b. The metal piece 59 is provided at such a position as to be attracted by a magnet 62 (see FIG. 18) that is buried in a glasses stand 60 when the shutter glasses 13 are mounted on the glasses stand 60.

FIG. 18 shows an exemplary state that shutter glasses 57 are mounted on the glasses stand 60 and the charging terminals 58a and 58b of the shutter glasses 13 are in contact with respective power supply terminals 61a and 61b of the glasses stand 60. When the shutter glasses 57 are mounted on the glasses stand 60 so as to face the respective power supply terminals 61a and 61b of the glasses stand 60, the charging terminals 58a and 58b come into contact with the power supply terminals 61a and 61b and a secondary battery 25a of the shutter glasses 57 is charged.

The magnet 62 which is a ferrite magnet or the like is buried in a surface portion of the glasses stand 60 near the power supply terminal 61a or 61b. The magnet 62 is buried in such a manner that its exposed surface is approximately flush with the surface of the glasses stand 60. The magnet 62 of the glasses stand 60 attracts the metal piece 59 of the shutter glasses 57, whereby the mounting state of the shutter glasses 57 is kept stable and the states of connections between the charging terminals 58a and 58b and hence the power supply terminals 61a and 61b are kept good.

The charging terminals of each pair of shutter glasses may be provided in a top portion or a front portion of the bridge 17, top portions of the rims 16a and 16b, side portions or top portions of the armors 18a and 18b, side portions or top portions of the temples 19a and 19b, etc. The positions of the charging terminals may be determined as appropriate in view of the convenience in disposing the power supply terminals in the glasses stand.

While certain embodiments have been described, these embodiments have been presented by way of example only, and are not intended to limit the scope of the invention. Indeed, the novel apparatus described herein may be embodied in a variety of other forms; furthermore, various omissions, substitutions and changes in the form of the apparatus described herein may be made without departing from the sprit of the invention. The accompanying claims and their equivalents are intended to cover such forms or modifications as would fall within the scope and sprit of the invention.

What is claimed is:

1. A video display apparatus comprising:
a cabinet; and
a glasses housing box provided in the cabinet and configured to house at least one pair of shutter glasses.

2. A video display apparatus comprising:
a cabinet;
a stand configured to support the cabinet; and
a glasses housing box provided in the stand and configured to house at least one pair of shutter glasses.

3. The apparatus of claim 1, wherein the glasses housing box comprises a charging module configured to perform charging on the shutter glasses.

4. The apparatus of claim 2, wherein the glasses housing box comprises a charging module configured to perform charging on the shutter glasses.

5. The apparatus of claim 2, wherein the glasses housing box is provided in a support portion of the stand.

6. The apparatus of claim 3, wherein the glasses housing box comprises a magnet disposed near the charging module and configured to attract a metal plate provided in each of the at least one pair of shutter glasses.

7. The apparatus of claim 4, wherein the glasses housing box comprises a magnet disposed near the charging module and configured to attract a metal plate provided in each of the at least one pair of shutter glasses.

8. The apparatus of claim 1, wherein the glasses housing box comprises a lid in a top wall of the cabinet.

9. The apparatus of claim 1, wherein the glasses housing box comprises a lid in a side wall of the cabinet.

10. The apparatus of claim 2, wherein the glasses housing box comprises a lid in a top wall of the stand.

11. Shutter glasses for 3D video display comprising:
liquid crystal shutters:
a secondary battery; and
a charging terminal which is provided in a bottom portion of a bridge of the shutter glasses and is to be brought into contact with a power supply terminal provided in a glasses housing box in charging the secondary battery.

12. The shutter glasses of claim 11, further comprising:
a metal plate provided near the charging terminal.
